(19) United States
(12) Patent Application Publication
(10) Pub. No.: US 2008/0276053 A1
(43) Pub. Date: Nov. 6, 2008

(54) Portable Device and Method for Controlling Deep Power Down Mode of Shared Memory

(75) Inventor: Jun Keun Lee, Gyeonggi-do (KR)

Correspondence Address: CANTOR COLBURN, LLP, 20 Church Street, 22nd Floor, Hartford, CT, 06103, US

(73) Assignee: FIDELIX CO., LTD., Sungnam-si, Kyunggi-do (KR)

(21) Appl. No.: 12/094,060

(22) PCT Filed: Feb. 3, 2007
(86) PCT No.: PCT/KR2007/000586

§ 371 Date: May 16, 2008

(30) Foreign Application Priority Data
Feb. 3, 2006 (KR) 10-2006-0010841

(51) Int. Cl. G06F 12/00

(52) U.S. Cl. 711/154; 711/E12.001

(57) ABSTRACT

The memory device may include a first determination unit for determining whether entry into a DPD mode is to be made by interpreting signals received from a first processor, and generating and outputting a corresponding first DPD entry signal; a second determination unit for determining whether entry into the DPD mode is to be made by interpreting signals received from a second processor, and generating and outputting a corresponding second DPD entry signal; and a DPD determination unit for performing control for operation in the DPD mode only when the first DPD entry signal and the second DPD entry signal are respectively received from the first determination unit and the second determination unit. In accordance with the present invention, a single piece of memory operates in the DPD mode even when a plurality of processors shares the memory, so that power consumption can be minimized.

### TECHNICAL FIELD

The present invention relates, in general, to shared memory and, more particularly, to a portable device and a method of controlling the deep power-down mode of the shared memory.

### BACKGROUND ART

Generally, a portable device includes a plurality of processors for performing respective preset functions. Each of the processors is coupled with memory for storing operation data, data to be processed, processed data and the like.

Generally, such memory operates in an operating state (for example, an active mode) or in a standby state (for example, in a standby mode or a Deep Power-Down (DPD) mode). When entering the standby state, the memory operates in the DPD mode, thus minimizing power consumption.

However, a conventional method of controlling a DPD mode, which enables memory to operate in a DPD mode, is a method that was proposed to be suitable for single port memory, and has a problem in that the method is not suitable for a shared memory system, in which a plurality of processors shares a single piece of memory.

### DISCLOSURE

### Technical Problem

Accordingly, the present invention has been made keeping in mind the above problems occurring in the prior art, and an object of the present invention is to provide a portable device and a method of controlling the DPD mode of shared memory, which, even when a plurality of processors shares a single piece of memory, enables the memory to operate in the DPD mode, thus minimizing power consumption.

Another object of the present invention is to provide a portable device and a method of controlling the DPD mode of shared memory, which minimizes the power consumed by the memory, thus maximizing the operation time period of a portable terminal.

### Technical Solution

In order to accomplish the above objects, in accordance with an aspect of the present invention, there are provided a memory device that operates in a DPD mode and is shared by a plurality of processors, and/or a portable terminal including the memory device.

The memory device according to a preferred embodiment of the present invention may include a first determination unit for determining whether entry into a DPD mode is to be made by interpreting signals received from a first processor, and generating and outputting a corresponding first DPD entry signal; a second determination unit for determining whether entry into the DPD mode is to be made by interpreting signals received from a second processor, and generating and outputting a corresponding second DPD entry signal; and a DPD determination unit for performing control for operation in the DPD mode only when the first DPD entry signal and the second DPD entry signal are respectively received from the first determination unit and the second determination unit. In this case, the signals may include a clock enable signal, a chip selection signal, a write enable signal, a row address strobe signal and a column address strobe signal.

In the memory device, the first determination unit or the second determination unit determines whether exit from the DPD mode is to be made by interpreting the signals received from the corresponding processor, and further generates and outputs a corresponding DPD exit signal, and the DPD determination unit performs control for operation in an active mode or in a standby mode when the DPD exit signal is received from one or more of the first determination unit and the second determination unit.

Each of the first determination unit and the second determination unit may include a command decoder for determining whether a burst termination command is received by interpreting the chip selection signal, the write enable signal, the address strobe signal and the column address strobe signal, which are received from the corresponding processor, and outputting a corresponding result value; a CKE storage unit for generating and outputting information about whether the clock enable signal, received from the corresponding processor, is inverted; and a command determination unit for generating and outputting the corresponding DPD entry signal when the result value indicates that the burst termination command has been received and when the clock enable signal is inverted from a first value to a second value.

The command determination unit generates and outputs the corresponding DPD exit signal when the clock enable signal is inverted from the second value to the first value.

The portable terminal according to another preferred embodiment of the present invention may include a first processor; a second processor; and a memory device coupled to each of the first processor and the second processor, wherein the memory device includes a first determination unit for determining whether entry into a DPD mode is to be made by interpreting signals received from a first processor, and generating and outputting a corresponding first DPD entry signal, the signals comprising a clock enable signal, a chip selection signal, a write enable signal, a row address strobe signal and a column address strobe signal; a second determination unit for determining whether entry into the DPD mode is to be made by interpreting signals received from a second processor, and generating and outputting a corresponding second DPD entry signal; and a DPD determination unit for performing control for operation in the DPD mode only when the first DPD entry signal and the second DPD entry signal are respectively received from the first determination unit and the second determination unit.

The first determination unit or the second determination unit determines whether exit from the DPD mode is to be made by interpreting the signals received from the corresponding processor, and further generates and outputs a corresponding DPD exit signal, and the DPD determination unit performs control for operation in an active mode or in a standby mode when the DPD exit signal is received from one or more of the first determination unit and the second determination unit.

Each of the first determination unit and the second determination unit may include a command decoder for determining whether a burst termination command is received by interpreting the chip selection signal, the write enable signal, the address strobe signal and the column address strobe signal, which are received from the corresponding processor, and outputting a corresponding result value; a CKE storage unit for generating and outputting information about whether the clock enable signal, received from the corresponding processor, is inverted; and a command determination unit for generating and outputting the corresponding DPD entry signal when the result value indicates that the burst termination command has been received and when the clock enable signal is inverted from a first value to a second value.

The command determination unit generates and outputs the corresponding DPD exit signal when the clock enable signal is inverted from the second value to the first value.

In order to accomplish the above objects, in accordance with another aspect of the present invention, there are provided a method of controlling the DPD mode of a memory device, and/or a recording medium in which a program for performing the method is recorded.

The method of controlling the DPD mode of a memory device according to an embodiment of the present invention may include the steps of a first determination unit determining whether entry into a DPD mode is to be made by interpreting signals received from a first processor, and generating and outputting a corresponding first DPD entry signal; a second determination unit determining whether entry into the DPD mode is to be made by interpreting signals received from a second processor, and generating and outputting a corresponding second DPD entry signal; and a DPD determination unit performing control for operation in the DPD mode only when the first DPD entry signal and the second DPD entry signal are received. In this case, the signals may include a clock enable signal, a chip selection signal, a write enable signal, a row address strobe signal and a column address strobe signal.

The method of controlling the DPD mode of a memory device may further include the steps of the first determination unit or the second determination unit determining whether exit from the DPD mode is to be made by interpreting the signals received from the corresponding processor, and generating and outputting a corresponding DPD exit signal, and the DPD determination unit performing control for operation in an active mode or in a standby mode when the DPD exit signal is received from one or more of the first determination unit and the second determination unit.

Each of the first determination unit and the second determination unit determines whether a burst termination command is received by interpreting the chip selection signal, the write enable signal, the address strobe signal and the column address strobe signal, which are received from the corresponding processor, and determines whether the clock enable signal, received from the corresponding processor, is inverted, and generates and outputs the corresponding DPD entry signal when the burst termination command is received and when the clock enable signal is inverted from a first value to a second value.

Each of the first determination unit and the second determination unit generates and outputs the corresponding DPD exit signal when the clock enable signal is inverted from the second value to the first value DPD.

### ADVANTAGEOUS EFFECTS

In accordance with the portable device and the method of controlling the DPD mode of shared memory, a single piece of memory operates in the DPD mode even when a plurality of processors shares the memory, so that power consumption can be minimized.

Furthermore, in accordance with the present invention, the power consumed by the memory is minimized, so that the operation time period of a portable terminal can be maximized.

### DESCRIPTION OF DRAWINGS

FIG. 1 is a circuit diagram showing a conventional circuit capable of operating in a DPD mode;

FIG. 2 is a diagram showing a command table in which commands transmitted and received between shared memory and processors are given;

FIG. 3 is a timing diagram showing a DPD mode entry period;

FIG. 4 is a timing diagram showing a DPD mode exit period; and

FIG. 5 is a block diagram showing the construction of a DPD mode controller according to a preferred embodiment of the present invention.

### MODE FOR INVENTION

A preferred embodiment of a unified codec method and device according to the present invention is described in detail with reference to the accompanying drawings below. For descriptions made with reference to the accompanying drawings, the same reference numerals are used throughout the different drawings to designate the same or similar components, and thus repeated description thereof is omitted. Furthermore, in the present specification, ordinal numbers (for example, “first” and “second”), used to describe the present invention, are used only to distinguish the same or similar components from each other, and do not limit the present invention.

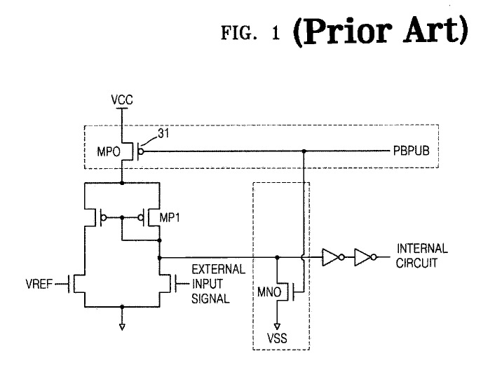

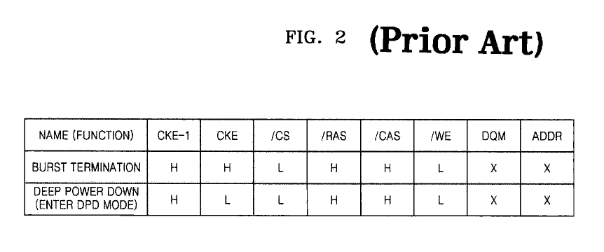

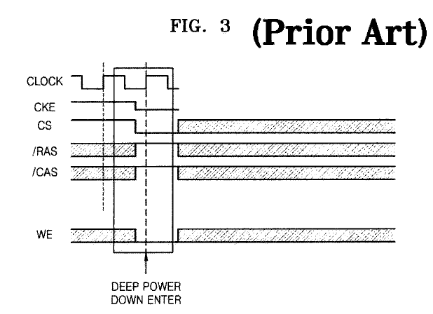

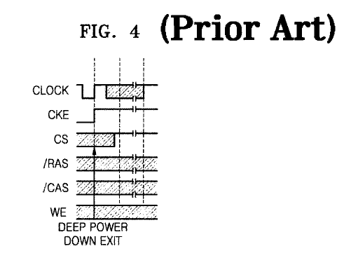

FIG. 1 is a circuit diagram showing a conventional circuit capable of operating in a DPD mode, FIG. 2 is a diagram showing a command table in which commands transmitted and received between shared memory and processors are given, FIG. 3 is a timing diagram showing a DPD mode entry period, and FIG. 4 is a timing diagram showing a DPD mode exit period.

Generally, memory is designed to simultaneously realize low power consumption, large cell capacity, and high speed. Accordingly, Dynamic Random Access Memory (DRAM) has a cell size smaller than Static Random Access Memory (SRAM), but provides a greater memory capacity for a given chip size, so that it is chiefly used for portable devices having spatial restrictions.

However, DRAM must perform predetermined refreshes, and consumes more current than SRAM. Due to such problems, the advantage of DRAM, that it has a small size and is thus suitable for use in portable devices, may be offset. The reason for this is because the power consumed by the memory is also increased due to the increased complexity and functions of portable devices and, thus, a battery having a large capacity may be required, or frequent recharges may be required.

To solve such problems, various types of circuits have been designed to reduce the power consumed by DRAM. For example, when DRAM is not operating in an active mode, the DRAM is switched to a standby mode or to a power-down mode, in which a small amount of current, or the minimum amount of current required to refresh or hold data in the DRAM, is provided.

U.S. Pat. No. 6,058,063 (the '063 patent) by Jang disclosed a circuit, shown in FIG. 1, for causing memory to enter a standby mode or a power-down mode.

An external clock enable signal CKE is used to interrupt the supply of power to specific circuits, such as input buffers, in a signal power-down mode. A power-down signal PBPUB induced by the external clock enable signal CKE is changed from a low level to a high level for signal power-down. The power-down signal PBPUB causes voltage Vcc to be cut off by turning off a transistor 31, and reduces output to ground by turning on a transistor 32.

Recently, in order to standardize the use of a DPD signal for controlling entry of DRAM into a DPD operation mode or exit from the DPD operation mode, the Joint Electron Device Engineering Council (JEDEC) proposed some standards. The proposal was made to allow the DPD signal for power-down of the DRAM to be used when the DRAM is not used.

The protocol for signaling the entry into and exit from the DPD mode proposed in the JEDEC standard specification is shown in FIGS. 2 to 4.

FIGS. 2 and 3 show a protocol for entry into the DPD mode.

As shown in FIGS. 2 and 3, the entry into the DPD mode is signaled when a clock enable signal CKE is changed from a high level to a low level, a chip selection signal CS and a write enable signal WE are at low levels, and row and column address strobe signals /RAS and /CAS, which are triggered by the change of a clock signal CLOCK from a low level to a high level, are at high levels.

Furthermore, as shown in FIG. 2, a burst termination operation is performed when the clock enable signal CKE is maintained at a high level, the chip selection signal CS and the write enable signal WE are at low levels, and the column address strobe signals /RAS and /CAS, which are triggered by the change of a clock signal CLOCK from a low level to a high level, are at high levels.

FIG. 4 is a timing diagram for signaling the exit from DPD mode.

As shown in FIG. 4, the exit from the DPD mode is signaled when the clock enable signal CKE, which is triggered by the change of the clock signal CLOCK from a low level to a high level, is changed to a high level. That is, none of the signals except for the clock enable signal CKE affect the exit from the DPD mode.

The protocol shown in FIGS. 2 to 4 has been used only for the purpose of signaling the entry into and exit from the DPD mode, but may be modified in various ways. For example, each of signals, such as a write enable signal WE and a column address strobe signal CAS, may be implemented so that the level thereof is inverted from a corresponding signal shown in FIG. 2.

The DPD mode may be used to reduce the power consumed by the DRAM when the DRAM is not in an active state. When the entry into the DPM mode is made to provide voltages, such as cell capacitor plate voltage, internal array power voltage, internal peripheral power voltage and reference power voltage, to the internal circuits of the DRAM, various internal power voltage generators are turned off. Furthermore, all of the input buffers of the DRAM, except for an auxiliary input buffer, which will be kept active in order to be able to receive a DPD exit mode signal, are turned off.

However, the conventional technology, described above, is only suitable for use as the DPD mode of single port memory coupled to a single processor.

In the case where a single processor independently has one or more pieces of memory, the size of a portable device increase and, thus, the manufacturing cost thereof increases. Recently, for these reasons, designs have specified that a plurality of processors share a single piece of memory.

For example, as the number of supplementary functions, such as a camera function, beyond conventional communication functions, increases in a mobile communication terminal, the mobile communication terminal includes a main processor for controlling the communication function and the operation of application processors, the one or more application processors for performing supplementary functions, which are designated in advance, under the control of the main processor, and multiple pieces of memory.

In this case, one or more memories may be shared by the plurality of processors. For this purpose, each memory may include a number of ports, corresponding to the number of processors coupled thereto.

Accordingly, for the reason that any of the plurality of processors coupled to a single piece of shared memory might need to use the currently shared memory, the shared memory cannot be instructed to operate in the DPD mode. However, specifying that the shared memory operate constantly in the active mode because there is the possibility that an arbitrary processor may use the currently shared memory may seriously increase power consumption, so that such unnecessary power consumption must be curtailed so that portable terminals, which are gradually being reduced in size, can be operated for a long time, therefore a scheme for minimizing power consumed by the shared memory is required.

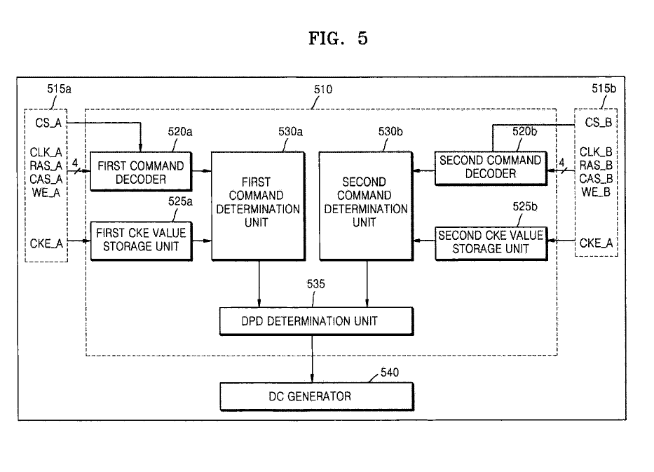

FIG. 5 is a block diagram showing the construction of a DPD mode controller according to a preferred embodiment of the present invention.

The DPD mode controller 510 is included in shared memory shared by a plurality of processors, is connected to the ports of the shared memory, which enables the shared memory to be coupled with the plurality of processors, and determines entry into and exit from DPD mode based on a signal received from corresponding processors. Since the method and construction in which the DPD mode controller 510 according to the present invention is coupled to the plurality of processors is similar to the method of sharing a conventional dual port memory and the structure of the conventional dual port memory, the descriptions thereof are omitted.

Referring to FIG. 5, the DPD mode controller 510 includes a first command decoder 520a, a second command decoder 520b, a first CKE value storage unit 525a, a second CKE value storage unit 525b, a first command determination unit 530a, a second command determination unit 530b, and a DPD determination unit 535.

The first and second command decoders 520a and 520b, the first and second CKE value storage units 525a and 525b and the command determination units 530a and 525b for each port are provided in order to receive signals from each coupled processor, interpret the received signals, and output result values. FIG. 5 shows the case where two processors are coupled to the shared memory. n processors (where n is a natural number of two or more) may be coupled to the shared memory. In this case, corresponding elements will be arranged in n pairs.

The first command decoder 520a receives a clock signal CLOCK, a write enable signal WE, and row and column address strobe signals /RAS and /CAS from a processor (hereinafter referred to as a ‘first processors’), which is coupled to correspond to first command decoder 520a, and determines whether a burst termination command is received using a combination of the signals.

When a chip selection signal CS and a write enable signal WE are at low levels, and row and column address strobe signals /RAS and /CAS, which are triggered by the change of the clock signal from a low level to a high level, are at high levels, the first command decoder 520a can determine that the burst termination command has been received.

If it is determined that the burst termination command has been received using the signals received from the first processors, the first command decoder 520a outputs a corresponding output value (hereinafter referred to as a ‘BT value’) to the first command determination unit 530a.

The first CKE value storage unit 525a records therein a clock enable signal CKE received from the first processors, compares a previous CKE value CKE−1 (refer to FIG. 2) and the current CKE value CKE (refer to FIG. 2), and outputs changed information to the first command determination unit 530a when the CKE value is changed from a high level to a low level. For example, the first CKE value storage unit 525 may be implemented to store only information about the clock enable signal CKE (that is, high or low state information). In this case, the first CKE value storage unit 525 can store the previous CKE value and the current CKE value. In the case where the first CKE value storage unit 525 stores only information about the clock enable signal CKE but does not output changed information to the first command determination unit 530a, the first command determination unit 530a can determine whether the CKE value is changed using information stored in the first CKE value storage unit 525a.

The first command determination unit 530 determines whether entry into the DPD mode for the first processor is to be made using the BT value received from the first command decoder 520a and primary provision information received from the first CKE value storage unit 525a (that is, the changed information received from the first CKE value storage unit 525a or information stored in the first CKE value storage unit 525a, noted similarly hereinafter).

If it is determined that the level of the CKE value has not changed based on the primary provision information received from the first CKE value storage unit 525a, the first command determination unit 530 determines that entry into the DPD mode for the first processor cannot be made. The reason for this is because the burst termination command has been received. In contrast, if it is determined that the level of the CKE value has changed (that is, that the level of the CKE value has changed from a high level to a low level) based on the primary provision information from the first CKE value storage unit 525a, the first command determination unit 530 determines that entry into the DPD mode for the first processor can be made, and outputs the first DPD entry signal to the DPD determination unit 535. In this case, the first command determination unit 530 may be implemented, for example, using a latch circuit.

When information about a new change in the level of the CKE value (that is, a change from a low level to a high level) is provided from the first CKE value storage unit 525a after the first command determination unit 530a has determined that the entry into the DPD mode for the first processor can be made, the first command determination unit 530 determines that exit from the DPD mode can be made, and outputs the first DPD exit signal to the DPD determination unit 535. In this case, command information interpreted by the first command decoder 520a may be ignored.

Since the second command decoder 520b, the second CKE value storage unit 525b and the second command determination unit 530b, shown in FIG. 2, are different from the first command decoder 520a, the first CKE value storage unit 525a and the first command determination unit 530a in that they interpret signals received from a different processor, but have the same functions as the first command decoder 520a, the first CKE value storage unit 525a and the first command determination unit 530a, the descriptions thereof are omitted. For convenience of understanding, output signals are referred to as a second BT value, secondary provision information, a second DPD entry signal and a second DPD exit signal, respectively.

When the first DPD entry signal is received from the first command determination unit 530a and when the second DPD entry signal is also received from the second command determination unit 530b, the DPD determination unit 535 determines that the memory can operate in the DPD mode, and inputs a DPD entry determination signal to a DC generator 540. In this case, a plurality of DC generators 540 may be used. The DC generator 540, the setting of which is made to stop the operation thereof when the DPD entry determination signal is input, stops the operation thereof to reduce the consumption of current. When the power consumption is, for example, 100 μA in the standby mode, control is performed to operate in the DPD mode, so that a circuit operation (refresh) in the memory is interrupted and, thus, power consumption is reduced to less than 1 μA, therefore unnecessary power consumption can be prevented, with the result that the lifespan of a battery can be extended.

In contrast, when the first DPD exit signal is received from the first command determination unit 530a, or when the second DPD exit signal is received from the second command determination unit 530b, the DPD determination unit 535 determines that the memory can be exited from the DPD mode, and inputs a DPD exit determination signal to the DC generator 540. In this case, a plurality of DC generators 540 may be used. When the DPD exit determination signal is input, the DC generator 540, stopped in response to the DPD entry determination signal, resumes operation.

Until now, the description of the method of controlling a DPM mode according to the present invention has been made based on the case where the entry into the DPD mode is made when the CKE value is changed from a high level to a low level by interpreting the signals from each of coupled processors, the chip selection signal CS and the write enable signal WE are at low levels, and row and column address strobe signals /RAS and /CAS, which are triggered by the change of the clock signal CLOCK from a low level to a high level, are at high levels. Furthermore, the description has been made based on the case where the exit from the DPD mode is made when the CKE value is changed from a low level to a high level.

However, this is an example of a protocol that can be used only for the purpose of signaling the entry into and exit from the DPD mode, and it is apparent that the protocol may be modified in various ways. For example, each of signals, such as a write enable signal WE and a column address strobe signal CAS, may be implemented so that the level thereof is inverted from a corresponding signal shown in FIG. 2.

### INDUSTRIAL APPLICABILITY

As described above, in accordance with the portable device and the method of controlling the DPD mode of shared memory, a single piece of memory operates in the DPD mode even when a plurality of processors shares the memory, so that power consumption can be minimized.

Furthermore, in accordance with the present invention, power consumption by the memory is minimized, so that the operation time period of a portable terminal can be maximized.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A memory device, comprising:
a first determination unit for determining whether entry into a Deep Power-Down (DPD) mode is to be made by interpreting signals received from a first processor, and generating and outputting a corresponding first DPD entry signal;
a second determination unit for determining whether entry into the DPD mode is to be made by interpreting signals received from a second processor, and generating and outputting a corresponding second DPD entry signal; and
a DPD determination unit for performing control for operation in the DPD mode enable signal, a row address strobe signal and a column address strobe signal.
only when the first DPD entry signal and the second DPD entry signal are respectively received from the first determination unit and the second determination unit;
wherein the signals comprise a clock enable signal, a chip selection signal, a write

2. The memory device according to claim 1, wherein the first determination unit or the second determination unit determines whether exit from the DPD mode is to be made by interpreting the signals received from the corresponding processor, and further generates and outputs a corresponding DPD exit signal, and
the DPD determination unit performs control for operation in an active mode or in a standby mode when the DPD exit signal is received from one or more of the first determination unit and the second determination unit.

3. The memory device according to claim 1, wherein each of the first determination unit and the second determination unit comprises:
a command decoder for determining whether a burst termination command is received by interpreting the chip selection signal, the write enable signal, the address strobe signal and the column address strobe signal, which are received from the corresponding processor, and outputting a corresponding result value;
a CKE storage unit for generating and outputting information about whether the clock enable signal, received from the corresponding processor, is inverted; and
a command determination unit for generating and outputting the corresponding DPD entry signal when the result value indicates that the burst termination command has been received and when the clock enable signal is inverted from a first value to a second value.

4. The memory device according to claim 3, wherein the command determination unit generates and outputs the corresponding DPD exit signal when the clock enable signal is inverted from the second value to the first value.

5. A portable terminal, comprising:
a first processor;
a second processor; and
a memory device coupled to each of the first processor and the second processor,
wherein the memory device comprises:
a first determination unit for determining whether entry into a DPD mode is to be made by interpreting signals received from a first processor, and generating and outputting a corresponding first DPD entry signal, the signals comprising a clock enable signal, a chip selection signal, a write enable signal, a row address strobe signal and a column address strobe signal;
a second determination unit for determining whether entry into the DPD mode is to be made by interpreting signals received from a second processor, and generating and outputting a corresponding second DPD entry signal; and
a DPD determination unit for performing control for operation in the DPD mode only when the first DPD entry signal and the second DPD entry signal are respectively received from the first determination unit and the second determination unit.

6. The portable terminal according to claim 5, wherein the first determination unit or the second determination unit determines whether exit from the DPD mode is to be made by interpreting the signals received from the corresponding processor, and further generates and outputs a corresponding DPD exit signal, and
the DPD determination unit performs control for operation in an active mode or in a standby mode when the DPD exit signal is received from one or more of the first determination unit and the second determination unit.

7. The portable terminal according to claim 5, wherein each of the first determination unit and the second determination unit comprises:
a command decoder for determining whether a burst termination command is received by interpreting the chip selection signal, the write enable signal, the address strobe signal and the column address strobe signal, which are received from the corresponding processor, and outputting a corresponding result value;
a CKE storage unit for generating and outputting information about whether the clock enable signal, received from the corresponding processor, is inverted; and
a command determination unit for generating and outputting the corresponding DPD entry signal when the result value indicates that the burst termination command has been received and when the clock enable signal is inverted from a first value to a second value.

8. The portable terminal according to claim 7, wherein the command determination unit generates and outputs the corresponding DPD exit signal when the clock enable signal is inverted from the second value to the first value.

9. A method of controlling a DPD mode of a memory device, comprising the steps of:
a first determination unit determining whether entry into a DPD mode is to be made by interpreting signals received from a first processor, and generating and outputting a corresponding first DPD entry signal;
a second determination unit determining whether entry into the DPD mode is to be made by interpreting signals received from a second processor, and generating and outputting a corresponding second DPD entry signal; and
a DPD determination unit performing control for operation in the DPD mode only when the first DPD entry signal and the second DPD entry signal are received;
wherein the signals comprise a clock enable signal, a chip selection signal, a write enable signal, a row address strobe signal and a column address strobe signal.

10. The method according to claim 9, further comprising the steps of:
the first determination unit or the second determination unit determining whether exit from the DPD mode is to be made by interpreting the signals received from the corresponding processor, and generating and outputting a corresponding DPD exit signal, and
the DPD determination unit performing control for operation in an active mode or in a standby mode when the DPD exit signal is received from one or more of the first determination unit and the second determination unit.

11. The method according to claim 10, wherein
each of the first determination unit and the second determination unit determines whether a burst termination command is received by interpreting the chip selection signal, the write enable signal, the address strobe signal and the column address strobe signal, which are received from the corresponding processor, and determines whether the clock enable signal, received from the corresponding processor, is inverted, and
generates and outputs the corresponding DPD entry signal when the burst termination command is received and when the clock enable signal is inverted from a first value to a second value.

12. The method according to claim 9, wherein each of the first determination unit and the second determination unit generates and outputs the corresponding DPD exit signal when the clock enable signal is inverted from the second value to the first value DPD.

13. The memory device according to claim 1, wherein each of the first determination unit and the second determination unit comprises:
a command decoder for determining whether a burst termination command is received by interpreting the chip selection signal, the write enable signal, the address strobe signal and the column address strobe signal, which are received from the corresponding processor, and outputting a corresponding result value;
a CKE storage unit for generating and outputting information about whether the clock enable signal, received from the corresponding processor, is inverted; and
a command determination unit for generating and outputting the corresponding DPD entry signal when the result value indicates that the burst termination command has been received and when the clock enable signal is inverted from a first value to a second value.

14. The memory device according to claim 13, wherein the command determination unit generates and outputs the corresponding DPD exit signal when the clock enable signal is inverted from the second value to the first value.

15. The memory device according to claim 14, wherein the command determination unit generates and outputs the corresponding DPD exit signal when the clock enable signal is inverted from the second value to the first value.

16. The portable terminal according to claim 7, wherein each of the first determination unit and the second determination unit comprises:
a command decoder for determining whether a burst termination command is received by interpreting the chip selection signal, the write enable signal, the address strobe signal and the column address strobe signal, which are received from the corresponding processor, and outputting a corresponding result value;
a CKE storage unit for generating and outputting information about whether the clock enable signal, received from the corresponding processor, is inverted; and
a command determination unit for generating and outputting the corresponding DPD entry signal when the result value indicates that the burst termination command has been received and when the clock enable signal is inverted from a first value to a second value.

17. The portable terminal according to claim 16, wherein the command determination unit generates and outputs the corresponding DPD exit signal when the clock enable signal is inverted from the second value to the first value.
